(19) United States
(12) Patent Application Publication
(10) Pub. No.: US 2006/0098427 A1
(43) Pub. Date: May 11, 2006

(54) Manually chargeable flash light

(76) Inventor: Peng-Tsung Yeh, Hsinchu City (TW)

Correspondence Address: Peng-Tsung YEH, P.O. Box No. 6-57, Junghe, Taipei, 235, TW

(21) Appl. No.: 10/984,743

(22) Filed: Nov. 10, 2004

(51) Int. Cl. F21L 13/00

(52) U.S. Cl. 362/192; 362/183

(57) ABSTRACT

A manually chargeable flash light comprises a casing, a lamp, and a power system, wherein the lamp is at least an LED (Light Emitting Diode), and the power system is composed of a gear set mechanism, a mini power generator, and an accumulator. The gear set mechanism is connected with a handle, which is connected with a handle arm outside the casing. Comparing to the current techniques, the present invention uses a manually driven power source to replace the conventional battery power, thereby guaranteeing power supply at any time without exchanging batteries. Therefore, the troublesome of depleting batteries without backup can be avoided, and energy can be saved due to the high efficiency of LED. Furthermore, it will not cause the pollution to the environment by waste batteries.

### BACKGROUND OF THE INVENTION

a) Field of the Invention

The present invention relates to a manually chargeable flash light, and more particularly to a flash light which is charged by hand.

b) Description of the Prior Art

A flash light is usually a necessary tool when walking at night or working in an outfield. There are two major charging methods of power supply for a current flash light: one is supplied by ordinary dry batteries, and the other is supplied by chargeable batteries. Therefore, a current flash light is normally powered by batteries. However, when batteries use up without any backup, it will cause great inconvenience to a user, and even induce unnecessary incidents. On the other hand, as a current flash light generally uses a low efficiency incandescent lamp, it will waste more energy. In addition, as the life of usage is limited for a dry battery or a chargeable battery, the disposed waste batteries will cause environmental pollution to the nature.

Accordingly, due to the obvious inconvenience and flaw in the practical application of a current flash light, improvement is necessary.

### SUMMARY OF THE INVENTION

The primary object of the present invention is to provide a manually chargeable flash light, which uses manually driven power source to replace conventional battery power, such that power supply can be guaranteed at any time, and energy can be saved without polluting the environment.

Accordingly, the present invention provides a manually chargeable flash light, which includes a casing, a lamp, and a power system, wherein the lamp is at least an LED (Light Emitting Diode), and the power system consists of a gear set mechanism, a mini power generator, and an accumulator. The gear set mechanism is connected with a handle, which is connected with a handle arm outside the casing. Accordingly, the gear set mechanism comprises five accelerating gears, wherein the first gear is connected with the handle, and the last gear is connected with a rotor of the mini power generator. The gear set mechanism and the mini power generator are installed on a middle plate.

Accordingly, a through-hole is located on a fixing seat, which is wrapped by a rubber sleeve. A fixing column, which is located on the handle arm, goes through the through-hole of the fixing seat inside the casing, and is fixed onto the middle plate.

Accordingly, the aforementioned casing is formed by fixing an upper and a lower lid.

Accordingly, a rubber pressing pad is located on the outer surface of the aforementioned upper lid. In addition, a switch panel is covered on the pressing pad having a switch.

Accordingly, a rubber plate is installed on the left and right side of the aforementioned casing, respectively.

Accordingly, a reflection shade is located at the front of the aforementioned casing, with an exterior lamp shade in front of the reflection shade.

Accordingly, the present invention uses the gear set mechanism, the mini power generator, and the accumulator to construct a power system. By rotating the handle arm outside the casing to convert the mechanical energy to electrical energy, and then saved into the accumulator, the LED of the flash light can be lightened through the discharging of the accumulator. Therefore, power supply can be guaranteed at any time without exchanging batteries, which can avoid the troublesome of depleting batteries without backup, and energy can be saved due to high efficiency of LED. Furthermore, the present invention will not cause pollution to the environment by waste batteries.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows an exploded view of the present invention.

FIG. 3 shows a perspective view of the transmission mechanism of the present invention.

FIG. 4 shows a schematic view of implementation of the transmission mechanism of the present invention.

FIG. 5 shows a schematic view of implementation of the circuit of the present invention.

### DETAILED DESCRIPTION OF THE PREFERRED EMBODIMENTS

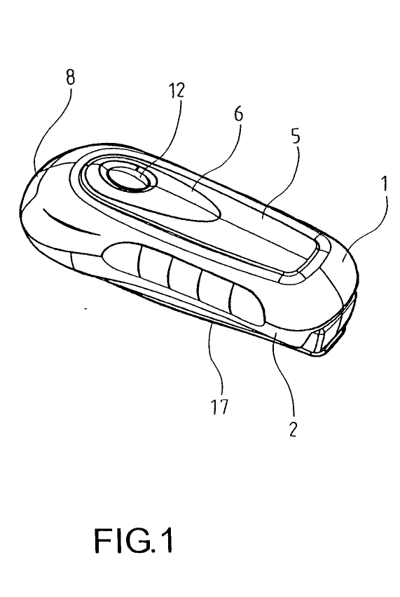

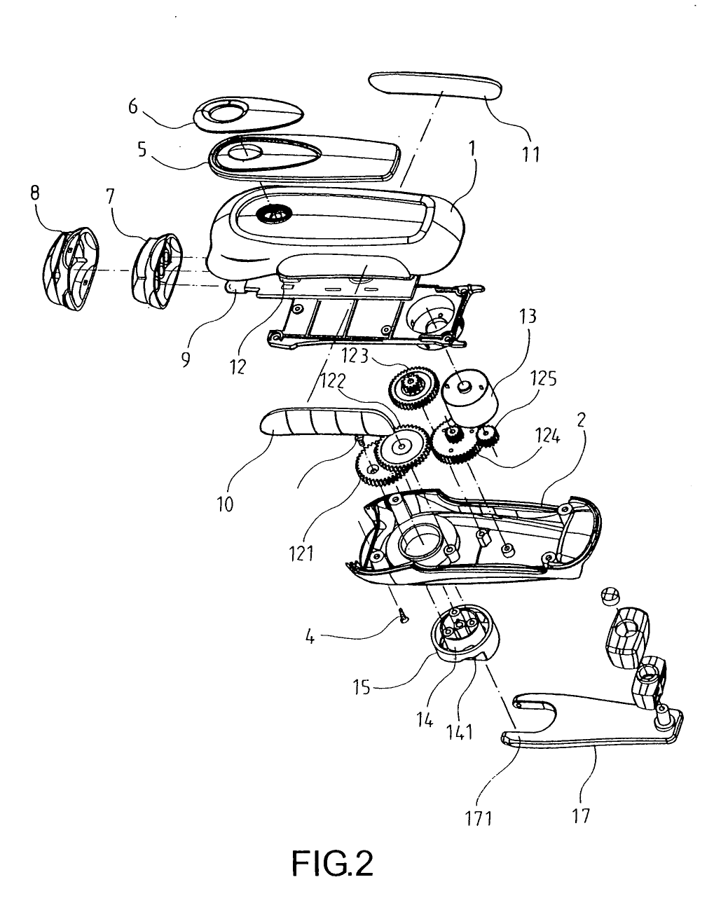

Referring to FIG. 1 and FIG. 2, it shows a perspective view and an exploded view of the present invention. The present invention primarily comprises a casing, a lamp, and a power system. The casing is composed of an upper lid 1 and a lower lid 2, fixed together by plastic pins 4. A rubber pressing pad 5 is located on the outer surface of the upper lid 1, and a switching panel 6 is covered on the pressing rubber pad 5. A reflection shade 7 is located at the front of the casing, and an exterior lamp shade 8 is located in front of the reflection shade 7, in which installed three LED 9 as lamps. A left rubber plate 10 and a right rubber plate 11 are installed at two sides of the casing, to facilitate holding by hand. Furthermore, a switch 12 is located on the pressing rubber pad 5. The switch 12 is connected with an interior circuit to fulfill the function of turning on and off one LED 9, and the function of turning on three LED 9.

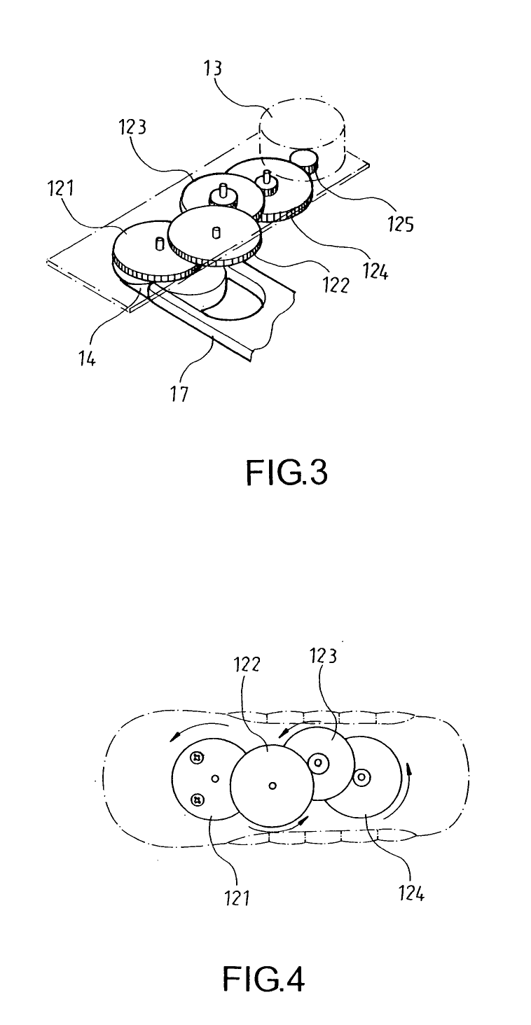

Referring to FIG. 3, it shows a perspective view of the transmission mechanism of the present invention. A power system, comprising a gear set mechanism, a mini power generator 13, and an accumulator (not shown in the Figure), is installed inside the aforementioned casing. For fixing the structure, the gear set mechanism and the mini power generator 13 can be installed on a middle plate. The gear set mechanism comprises five accelerating gears 121, 122, 123, 124, and 125, wherein a fixing seat 14 with a central through-hole 141 is fixed onto the first gear 121. The fixing seat 14 is wrapped by a rubber sleeve 15. A handle arm 17 with a fixing column 171 is located at the outer surface of the lower lid 2 of the casing, with the fixing column 171 of the handle arm 17 going through the through-hole 141 on the fixing seat 14 inside the casing, and fixed onto the first gear 121 via a screw 16. The last gear 125 is fixed on a rotor of the mini power generator 13.

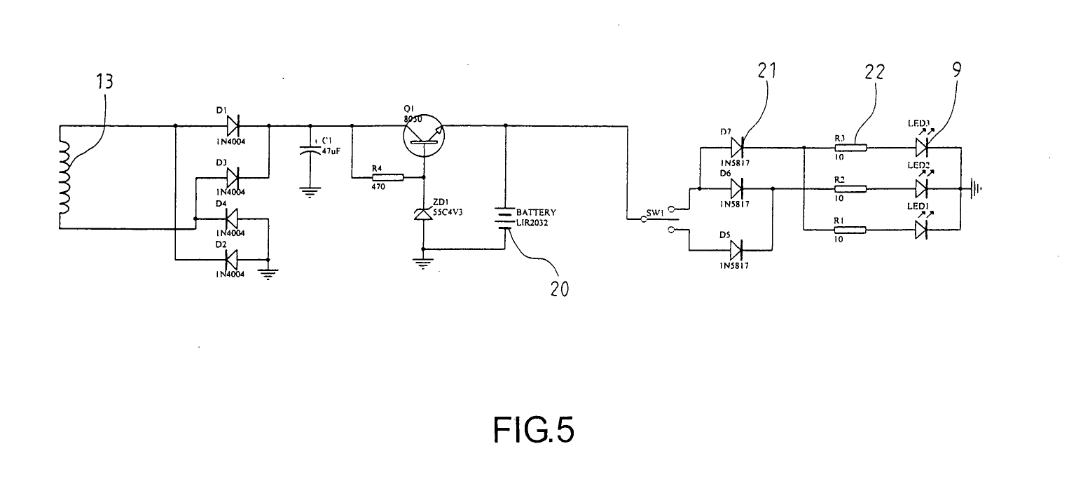

Referring to FIG. 4, it shows a schematic view of implementation of the transmission mechanism of the present invention. When charging the accumulator of the present invention, a user only needs to rotate the handle arm 17 outside the casing. The handle arm 17 will rotate the fixing seat 14, and the first gear 121 will be rotated in turn. At this time, the gear set mechanism is working, and the rotating speed is increased via the fitting of each of the five accelerating gears, thereby inducing the rotor of the mini power generator 13 to spin in a high speed to convert the mechanical energy to the electrical energy. The electrical energy can pass through conductors to a rectifier, and a regulating circuit, to the accumulator for charging, after rectified and regulated.

Referring to FIG. 5, it shows a schematic view of implementation of the circuit of the present invention. When discharging the accumulator of the present invention, electric current can flow out of the anode of the accumulator via the selection of power switch, which will pass through a one way conducting diode 21, and a resistor 22, then through one or three LED 9, to lighten the LED 9. Finally, side light of the LED 9 will be focused through a concave mirror inside the reflection shade 7, and lighten forwardly with stronger ray through the exterior lamp shade 8.

Accordingly, the present invention uses the gear set mechanism, the mini power generator, and the accumulator to construct a power system. By rotating the handle arm outside the casing to convert the mechanical energy to electrical energy, and then saved into the accumulator, the LED of the flash light can be lightened through the discharging of the accumulator. Therefore, power supply can be guaranteed at any time without exchanging batteries, which can avoid the troublesome of depleting batteries without backup, and energy can be saved due to high efficiency of LED. Furthermore, the present invention will not cause pollution to the environment by waste batteries.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A manually chargeable flash light, primarily comprising a casing, a lamp, and a power system, wherein the lamp is at least an LED;
the power system is composed of a gear set mechanism, a mini power generator, and an accumulator, wherein the gear set mechanism is connected with a handle, which is connected with a handle arm outside the casing.

2. The manually chargeable flash light according to claim 1, wherein the gear set mechanism is composed of five accelerating gears, with the first gear fixed with the handle, and the last gear fixed with a rotor of the mini power generator, and the gear set mechanism and mini power generator installed on a middle plate.

3. The manually chargeable flash light according to claim 1, wherein a through-hole is located on a fixing seat wrapped by a rubber sleeve; a fixing column passing through the through-hole of the fixing seat inside the casing is located on the handle arm, and fixed onto the middle plate.

4. The manually chargeable flash light according to claim 2, wherein a through-hole is located on a fixing seat wrapped by a rubber sleeve; a fixing column passing through the through-hole of the fixing seat inside the casing is located on the handle arm, and fixed onto the middle plate.

5. The manually chargeable flash light according to claim 1, wherein the casing is composed of an upper and a lower lid.

6. The manually chargeable flash light according to claim 2, wherein the casing is composed of an upper and a lower lid.

7. The manually chargeable flash light according to claim 4, wherein a pressing rubber pad is located on the outer surface of the upper lid, and a switching panel is covered on the pressing rubber pad having a switch.

8. The manually chargeable flash light according to claim 4, wherein a rubber plate is located at two sides of the casing.

9. The manually chargeable flash light according to claim 4, wherein a reflection shade is located at the front of the casing, with an exterior lamp shade in front of the reflection shade.
